(19) United States
(12) Patent Application Publication
(10) Pub. No.: US 2004/0088204 A1
(43) Pub. Date: May 6, 2004

(54) Method of retrieving a travel transaction record and an image of its supporting documentation

(76) Inventors: Christopher Plum, Natural Bridge, VA (US); Michael Dubois, Tampa, FL (US); Wayne Polk, Riverview, FL (US); Mark Diskin, Tampa, FL (US); Rebecca Briggs, Crestwood, KY (US); Bruce Berndt, Fairfax, VA (US); Keith Venzke, Falls Church, VA (US); Tom Cooper, Tampa, FL (US)

Correspondence Address: Blaney Harper, Esq., Jones, Day, Reavis & Pogue, 51 Lousiana Avenue, N.W., Washington, DC, 20001-2113, US

(21) Appl. No.: 10/283,906

(22) Filed: Oct. 30, 2002

(51) Int. Cl. G06F 17/60; H04L 9/00

(52) U.S. Cl. 705/5; 705/1; 713/200

(57) ABSTRACT

The present invention is a computer-implemented method of retrieving raw data from a database that stores data pertaining to multiple travel transaction records and travel documents. That is, the raw data stored in the database includes the information found on a travel document. A summary of the travel transaction record is based on information in the supporting documents. The computer implemented method includes the step of retrieving the raw data and dynamically creating a summary of a travel transaction record concerning all related documents. Moreover, the computer-implemented method further includes the step of dynamically creating a document image of such supporting documentation using the raw data stored in the database.

### TECHNICAL FIELD

This invention relates to a method of accessing a secure travel service information system and, more particularly, a method for accessing from the travel service information system a summary of travel transaction records and their supporting documents.

### BACKGROUND

Domestic and foreign air carriers, (e.g., American Airlines, Continental Airlines, Delta, British Airways, etc.) sell tickets directly to consumers. Travel agencies also sell tickets to consumers. That is, travel agencies assist consumers with their travel plans by making reservations on air carriers and ticketing those reservations. Travel agencies may also assist consumers by making reservations and issuing tickets on ground carriers (e.g., railroads and buses). Thus, the term “carrier” shall include both air and ground carriers as well as any type of transportation provider.

Travel agencies issue to passengers paper tickets, coupons and/or electronic tickets all of which are redeemable for travel. Travel agencies settle various financial transactions between carriers and travelers. Airlines Reporting Corporation (“ARC”) operates an accreditation program on behalf of participating air and rail carriers. ARC accredits Agents that sell tickets to the general public. ARC also accredits Corporate Travel Departments (“CTDs”) which may purchase tickets for their employees and representatives. “Agents” and “CTDs” are hereinafter referred to collectively as travel agencies.

Travel agencies accredited by ARC report, remit and settle such financial transactions through ARC. ARC administers the “Standard Ticket and Area Settlement Plan” (herein referred to as the “ASP”). The ASP was developed to process the reporting and settlement of transactions issued by accredited travel agencies on behalf of ARC participating carriers. The ASP processes the sales and remittances for over 34,000 authorized travel agency locations in the United States. The essential elements of the ASP are: standard traffic documents instead of individualized carrier documents; one step imprinting on documents of the issuing carrier's name and the travel agent's validation at the time the document is issued; a consolidated sales report and single-sum remittance for all carriers to a designated area bank; an area bank, acting as a clearing house, to determine the amount due each carrier and transmit such amounts to the carrier; computer generated sales summaries for each agent and carrier for their respective sales activity; and remitting to the travel agent, any appropriate remittance.

Historically, travel agencies have used (and some still use) a manual system of recording, maintaining and processing travel transaction and financial settlement information. Such a manual recording system is extremely inefficient. Thus, ARC introduced the Interactive Agent Reporting (“IAR”) system, which is an electronic sales reporting system that has the functionality to electronically record, maintain and process travel transactions, including automated and manual ticket sales, refunds and exchanges, and to record, maintain and process financial settlement information. The IAR system interacts with an TAR database system, which stores sales and other information (including but not limited to carrier identification, fare basis and commission rate) recorded from completed transactions reported by accredited travel agencies.

The IAR database receives information from the Computer Reservation System (“CRS”) and stores that information for approximately three weeks. The IAR system also incorporates software routines that retrieve the stored data from the IAR database. However, the data retrieved from the IAR database is presented in the form of raw data and without context. That is, it would not be readily apparent to someone what the retrieved data meant unless that person had the particular knowledge with which to interpret that data. For example, if the retrieved data originated from a ticket, the retrieved data from the IAR database would not be presented as it appeared on the original ticket.

Sales reports are typically sent to and recorded (i.e., stored) on the IAR database on a weekly basis, and travel agencies are required to retain a duplicate copy of each weekly sales report. Specifically, section XIV of the Agent Reporting Agreement requires each travel agent to retain, for at least two years, a duplicate copy of each weekly sales report. Moreover, the Agent Reporting Agreement requires each travel agent to retain, for the same period, the supporting documents used to generate the sales report. The supporting documents include various types of items. Those items may include the following: Ticket; Agent Automated Deduction (AAD); Agent Coupon (AGT); Authority to Refund a PTA transaction (ARP); Auditor Coupon (AUD); Type A certificate (CER); Companion coupon (CMP); Conjunction coupon (CNJ); Coupon returned in a refund or exchange (CPN); Credit memo (CRM); Debit memo (DBM); Carrier non-transport document (NTR); Recall Commission Statement (RCC); Refund Exchange Notice (REN); Regenerated Stock Control Number (RSN); Unapplied Void Transaction (UAV); Type B voucher (VOU); a Miscellaneous Charge Order (MCO) and other supporting documents.

Most travel agencies store the sales reports and supporting documentation in “hard copy” paper form. However, some travel agencies store the sales reports and supporting documents on microfiche, microfilm or some other optical storage medium, such as a CD-ROM, an optical disk, a DVD or a laserdisc. When the sales reports are stored on an optical storage medium, the sales reports are stored as document images. Although, optical storage devices can store more sales reports in a given amount of physical space in comparison to hard copies of such reports, document images of the reports consume a fair amount of memory. Nevertheless, both the hard copy and optically stored sales reports and supporting documents are typically stored at the respective agency's location.

There are times when the validating carrier or ARC may wish to see or inspect the supporting documentation. Therefore, travel agencies are required to ensure that the stored copies of the sales reports and the supporting documents are accessible to ARC and the carriers. However, because the supporting documents are typically stored at the travel agent's location, it may be difficult and time consuming for the carrier and/or ARC to obtain a copy of the supporting document(s). Furthermore, it may be difficult for the travel agent, ARC and the validating carrier to search and locate the requested documentation. What is needed is a system for allowing a travel agent, ARC and the validating carrier convenient access to the supporting documents for the weekly reports.

Moreover, there is a need to increase the security for the weekly reports and supporting documents. That is, there is a need to maintain the integrity of the original weekly reports and records from which the weekly reports are generated in order to prevent any type of fraud. Conventional record keeping methods are susceptible to fraudulent practices because the records may be altered, thereby leading to the reporting of misleading transaction information. Thus, what is also needed is a secure system that stores the weekly reports and the supporting documents for the weekly reports.

### OBJECTS OF THE INVENTION

It is an object of the invention to provide a travel agent, ARC and the validating carrier for a particular travel transaction convenient and secure access to the document(s) supporting the travel transaction record.

It is another object of the invention to provide a travel agent, ARC and the validating carrier a more friendly method of searching for a travel transaction record and its supporting documentation.

It is another object of the invention to make the travel documents available to travel agencies, carriers and ARC as document images.

It is another object of the invention to make the document images of the travel documents available to travel agencies and carriers via the Internet and the World Wide Web.

It is a further object of the invention to allow the travel agencies, carriers and ARC to view the travel documents locally (i.e., remotely).

It is a further object of the invention to allow the travel agencies, carriers and ARC to print the travel documents locally.

It is even a further object of the invention to provide a travel agent, ARC and the carrier related to a particular travel transaction secure access to the document(s) supporting the travel transaction record.

It is even a further object of the invention to create a secure and central repository for the document(s) supporting the travel transaction record.

### SUMMARY OF THE INVENTION

The present invention is computer-implemented method of retrieving an image of a document supporting a travel transaction record. The present invention is made possible through software that is incorporated on a server computer. The server computer communicates with a database that hosts the raw data of numerous travel transaction records and from which summaries of travel transaction records are created. Moreover, the raw data in the database provides the server computer with data to create a document image of the documents supporting the travel transaction record. That is, the software includes code for facilitating the communication between the database, which hosts the raw data of the travel transaction records and the supporting documents, and the requesting client computer. That software not only facilitates communication but also dynamically creates the travel transaction records and document images of the supporting documents using the raw data stored on the database.

As a result, the present invention allows a user of a client computer to search via a network, such as the Internet, for a travel transaction record remotely located on a database hosted by ARC. Upon locating the particular transaction record in which the user is interested in viewing, the present invention retrieves from the database the raw data relating to that transaction record and dynamically creates a summary of the transaction record. By retrieving the raw data, the present invention can also dynamically create a document image of the documents supporting the travel transaction record. Once the client computer creates the document image of the travel document, the user of the client computer may view it on the computer's display and/or print the document on a local printer, thereby providing ARC and the carriers convenient access to the documents supporting the transaction records.

By using the raw data to create document images of the travel document, a document image of the travel document does not have to be stored. Rather, only the raw data from the travel document is stored on the database. And storing the raw data consumes less memory than storing the document image of the travel document from which the raw data is obtained.

Furthermore, storing the raw data in a central repository controlled by ARC maintains security and integrity of the data. That is, all reports, transaction records and travel documents are created from the same data, regardless of who requests the report, transaction record and/or travel document. Because the travel agencies, carriers and ARC will use the same data to generate their respective transaction records and travel documents, any discrepancies among the parties can be resolved by relying on the same set of common data.

Accordingly, the present invention includes a computer-implemented method for creating a document image of a travel document, the method comprising the steps of a client computer establishing communication with a server computer through a network of computers, wherein the server computer communicates with a database, wherein the database includes data pertaining to multiple travel documents, the server computer receiving a request from the client computer for a travel document, the server computer retrieving data corresponding to the travel document from the database, the server computer creating a document image of the travel document using the retrieved data and sending the document image to the client computer via the network.

The foregoing features and advantages of the present invention will become more apparent in light of the following detailed description of exemplary embodiments thereof as illustrated in the accompanying drawings.

### BRIEF DESCRIPTION OF DRAWINGS

FIG. 1 is a block diagram of an network based system for creating a summary of a travel transaction record and creating document images of the travel documents supporting that travel transaction record from a database that hosts the data used to create the summary and the document image according to one embodiment of the present invention.

FIG. 2 is a block diagram of a computer system used for creating a summary of travel transaction records and document images of the documents supporting the travel transaction records.

FIG. 3 is a login screen 300 according to one embodiment of the present invention.

FIG. 4 is an input screen 400 according to one embodiment of the present invention.

FIG. 5 is a response screen 500 illustrating a summary of a travel transaction record that includes four documents according to one embodiment of the present invention.

FIG. 6 illustrates a document image 600 of a document overlaying the response screen 500, wherein the document image corresponds to one item in the summary of the travel transaction record listed in the response screen 500.

### DESCRIPTION OF THE PREFERRED EMBODIMENTS

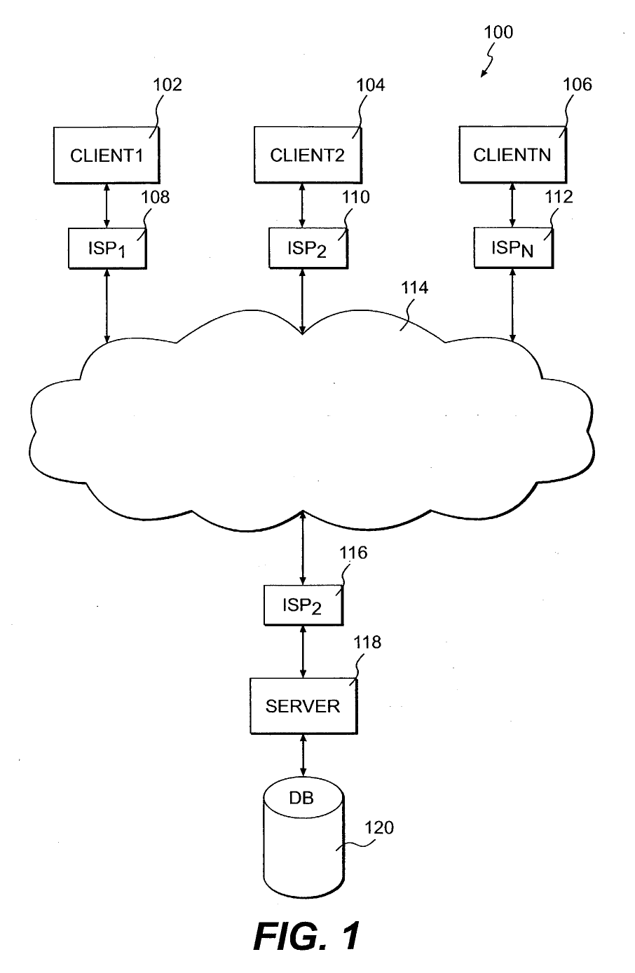

Referring to FIG. 1, there is shown a block diagram of a network based system 100 for retrieving a summary of a travel transaction record and document images of the travel documents supporting the travel transaction record from a database 120. The network based system 100 is a client-server model. That is, client computers 102, 104, 106 (e.g., personal computers) are located at the travel agency's or the carrier's premises, and a server computer 118 is located at ARC or some location controlled by ARC. Each client computer 102, 104, 106 is coupled to a computer network 114 through a communication channel (not shown) which, in turn, is connected to an internet service provider (ISP) 108, 110, 112.

The computer network 114 may be the Internet, the World Wide Web or some other network of computers, such as an Intranet. The Internet is a global network of millions of computers, and the World Wide Web is a system of Internet servers (e.g., computers) that support specifically formatted documents. The documents supported by the World Wide Web are typically formatted in a script called Hyper Text Markup Language (“HTML”), which supports links to such documents.

Although the remainder of the specification will discuss the operation between one client computer 102 and the server computer 118, it shall be understood that the present invention is not limited to operating with only one client computer. Rather, the scope of the present invention includes simultaneous communication between the server computer 118 and multiple client computers 102, 104, 106 (i.e., 1 to n). Any one of the client computers may be used by a travel agent, a carrier or ARC.

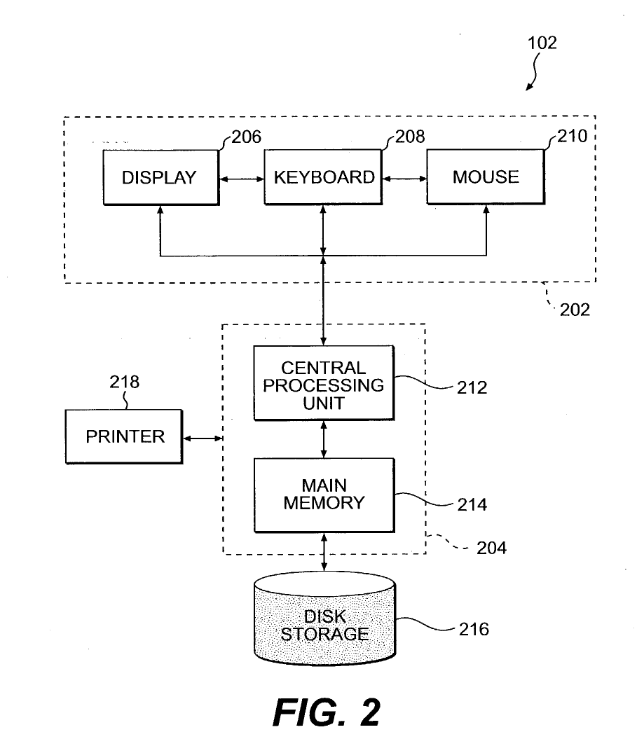

FIG. 2 illustrates one embodiment of a client computer 102. The client computer 102 comprises a central processing unit (CPU) 212, such as a 486-type microprocessor, and a main memory 214 which is coupled to the central processing unit 212. The client computer 102 also comprises an input/output (I/O) system 202, which may include a display 206, a keyboard 208 and a mouse 210. Although it is not shown, the client computer 102 also comprises conventional hardware, such as a modem or a serial port, for communicating (e.g., connecting) with the network 114. The client computer 102 may also optionally include an auxiliary disk storage unit 216 if additional memory is required. Furthermore, the client computer 102 may be connected to a printer 218, which allows a user to print images or documents that are viewable on the display 206.

Although it is not shown, the client computer 102 also comprises software (i.e., computer readable program code), which is typically stored in the main memory 214 or disk storage unit 216. The software may include an operating system, such as Microsoft Windows, a web browser such as Microsoft's Internet Explorer or Netscape Navigator, and other conventional routines for facilitating the display and communication of data to and from the network 114.

The server computer 118 includes hardware, such as a central processing unit, a main memory and communications hardware, similar to the client computer 102. However, the server computer's hardware is typically larger and more powerful than that of the client computer. The server computer 118 also incorporates conventional server software for communicating to and from the network 114. Furthermore, the server computer 118 incorporates software (i.e., code) that allows it to communicate with a database 120. That is, the software incorporated in the server computer 118 allows it to perform the method of the present invention. Thus, the software, the central processing unit, which executes the code, and the communications hardware (if necessary) provide the server computer 118 with the means for performing the steps of receiving and sending the information to and from the client computer 102 and the database 120.

The database 120 includes multiple travel transaction records. A travel transaction record includes at least one travel document (hereinafter “document”). A document may be one of the following: Ticket; Agent Automated Deduction (AAD); Agent Coupon (AGT); Authority to Refund a PTA transaction (ARP); Auditor Coupon (AUD); Type A certificate (CER); Companion coupon (CMP); Conjunction coupon (CNJ); Coupon returned in a refund or exchange (CPN); Credit memo (CRM); Debit memo (DBM); Carrier non-transport document (NTR); Recall Commission Statement (RCC); Refund Exchange Notice (REN); Regenerated Stock Control Number (RSN); Unapplied Void Transaction (UAV); Type B voucher (VOU); a Miscellaneous Charge Order (MCO) and other supporting documents. For example, if a customer purchases a ticket with a voucher, the voucher is treated as one document and the ticket is treated as another document. If the customer later exchanges the ticket for another ticket, then the second ticket will be treated as a third document. Moreover, each flight segment within a roundtrip ticket may be considered a separate document.

In order to track an entire transaction, which may include multiple documents, such as described in the example above, ARC assigns a common transaction number to all related documents. Thus, all related documents will have the same transaction number, and all of the related documents create a single transaction. Accordingly, a record of the transaction includes all related documents. Moreover, a summary of the travel transaction record is a summary of the documents constituting a particular transaction. Thus, the summary of the travel transaction record includes information contained in each related document.

The database 120 includes the raw data for all documents. Each document includes information and that information, along with its transaction number, is stored as data within data elements in the database 120. The summaries of the travel transaction records and the document images of the document are dynamically created by the server computer 118, which returns the data from the corresponding data elements of the database 120. As will be discussed in more detail below, the present invention allows a user to search for both “Settled” and “Initial” transaction data. Thus, the database 120 includes data for both settled and initial travel transaction records. The database receives its data from the CRS or the IAR upon a document being created.

The present invention allows a user of a client computer 102 to search, via the network, for a travel transaction record remotely located on a database 120 hosted by ARC. The server computer 118 dynamically creates a summary of the travel transaction record from the data stored on the database 120. The summary includes a list of documents that constitute the travel transaction record and various information from each document. Once the server computer 118 creates the summary of the travel transaction record, the summary is sent to the client computer 102, where the user can view it. If she so desires, the user of the client computer 102 may also print a copy of the summary locally using a web browser.

Furthermore, the present invention allows the user of client computer 102 to request the supporting documentation that corresponds to each of the items listed on the summary of the travel transaction record. That is, the present invention allows the user of client computer 102 to retrieve a document image of the document(s) that supports the travel transaction record. If the client computer 102 requests a document, the server computer 118 retrieves the raw data from the database 120 corresponding to that document. The server computer 118 then dynamically creates a document image of the document from the data retrieved from the database 120. As discussed above, there are various types of documents. And when the client computer 102 requests a document from the server computer 118, the server computer 118 recognizes the type of document being requested. Upon recognizing the type of document being requested, the server computer 118 dynamically creates a document image of a template corresponding to the type of requested document. Thus, the server computer dynamically creates a document image of a document by dynamically creating a template and inserting the retrieved data into that template. Once the server computer 118 creates the document image of the document, the document image is sent, via the network 114, to the client computer 102, thereby allowing the user to also view and print the supporting document(s). Accordingly, the server computer 118 includes the necessary software (e.g., code) and hardware to facilitate the communication (e.g., receipt and delivery) of information (e.g., data) between the client computer 102 and the database 120 as described in more detail below.

Before a client computer 102 is allowed access to the information stored on the database 120, the client computer 102 typically requests access from the server computer 118 to the automated retrieval system. One means of requesting access to the automated retrieval system may be initiated by the client computer 102 requesting a login screen from the server computer 118. The login screen is generally in the form of a web page found on a web site hosted by the server computer 118. Thus, the user may request the web page by typing (e.g., entering) the Internet address for the web page into the client computer's 102 web browser, which sends the request for the corresponding web page to the server computer 118 via the network 114 and ISPs 108, 116.

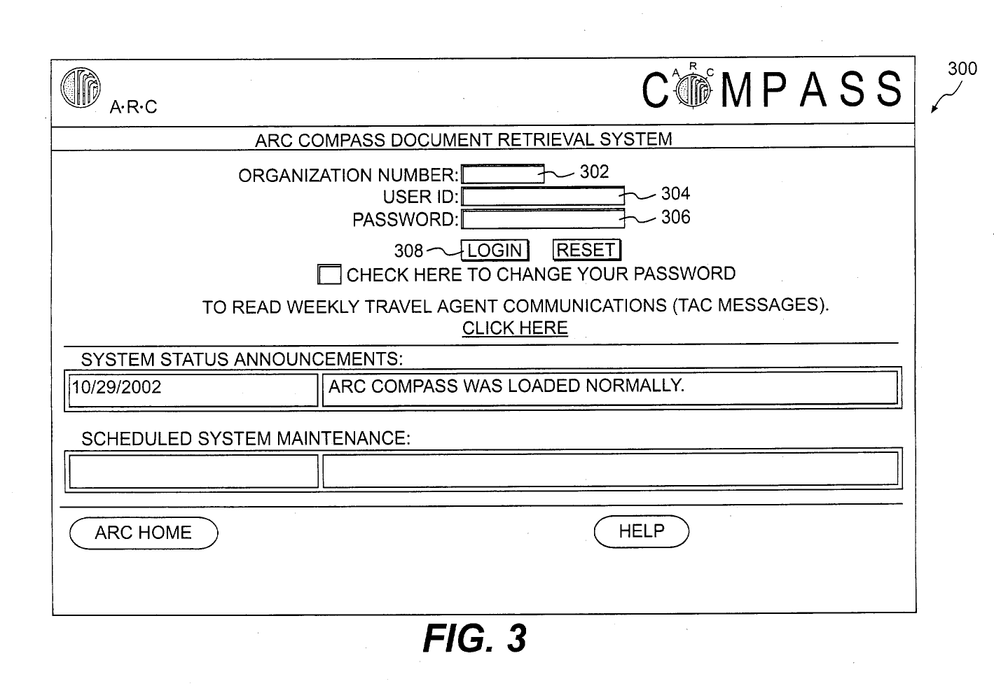

Upon receiving the request, the server computer 118 sends, via the network 114, to the client computer 102, a login screen similar to the one illustrated in FIG. 3. The login screen is typically in the form of a graphical user interface (“GUI”). Thus, the login screen 300 of FIG. 3, as are the other screens of the invention, is illustrated a GUI.

The login screen typically requires one or more access codes from the user of the client computer 102. For example, the login screen 300 of FIG. 3 may require the user to provide an organization number 302, a user ID 304 and a password 306. The organization number 302 is an eight digit numeric code assigned by ARC via the International Air Transport Association (“IATA”) to the travel agency or a three digit carrier code. The organization number 302 may also be referred to as an either agency code number (“ACN”) or an ARC number. The user ID 304 is typically a six to eight alphanumeric character identifier assigned to an individual user within the corresponding travel agency. In other words, there may be multiple user IDs associated with one organization number. The password 306 is typically a unique combination of at least eight characters and/or numbers associated with the user ID 304.

After entering the requested access codes, the user clicks the “Login” button 308, thereby instructing the web browser on the client computer 102 to send the access codes to the server computer 118. The server computer 118 validates the access codes by comparing the entered access codes to valid access codes in a look-up table stored in the server's memory or an auxiliary database (not shown). If one or more of the entered access codes does not match the valid access codes, the server computer 118 may send to the client computer 102 a screen requesting the user to reenter the access codes. The server computer 118 may include additional security measures, such as requiring the user to change her password after a certain number of days. Thus, depending upon when the user last changed her password, the server computer 118 may send to the user a screen requesting the user to change her password. Moreover, all messages between the client computer 102 and the server computer 118 can be encrypted using conventional encryption technology.

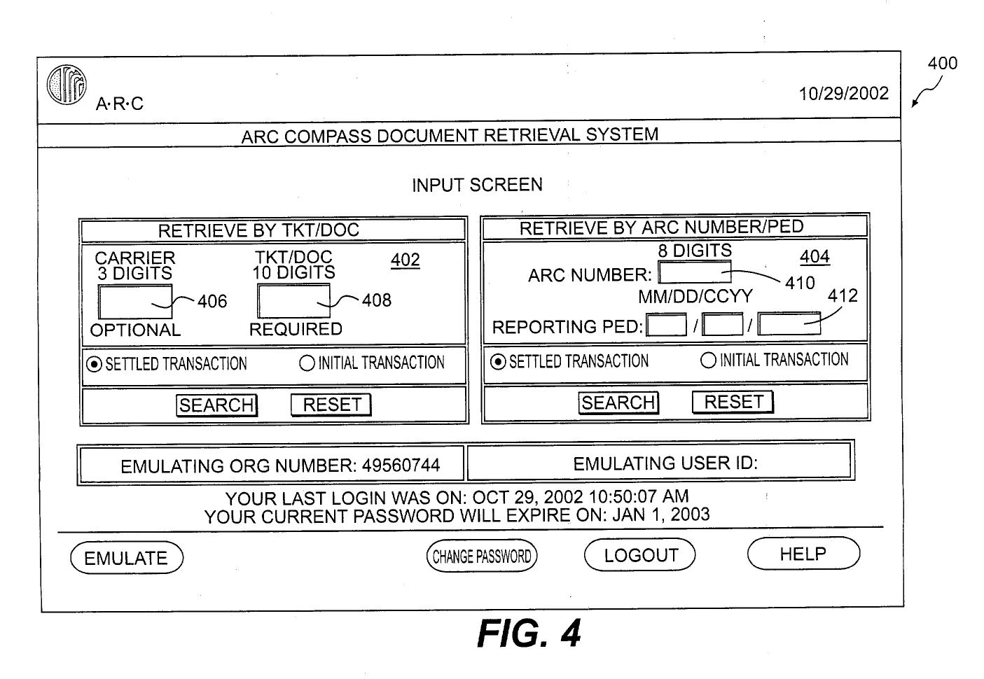

Assuming the server computer 118 validates the access codes entered by the user, the server computer 118 then sends to the client computer 102 a retrieval screen, such as the GUI retrieval screen 400 illustrated in FIG. 4. The retrieval screen 400 indicates the date that the user last logged onto the automated retrieval system and the date the user's password is set to expire. Moreover, the retrieval screen 400 has two portions from which a search may be initiated. One portion 402 allows the user to search for a travel transaction record by entering a document number such as a ticket number, and the other portion 404 allows the user to search for travel transaction records by an ARC number within a certain time period. The document number includes ten digits. And, as discussed above, a ticket is one type of document. Thus, a ticket number includes ten digits. The ticket number is defined by the Air Transport Association (“ATA”) Ticketing Resolutions.

As also discussed above, an ARC number is a unique identifier assigned to a travel agency by ARC at the time the travel agency receives ARC accreditation. As used in this application, an ARC number includes eight digits. Thus, searching by an ARC number allows an authorized user to view all appropriate documents associated with a specific travel agency within a particular timeframe. For example, a carrier can only see documents (i.e., tickets) relating to that carrier (i.e., sold by that carrier or sold by a travel agency on behalf of that carrier). Similarly, a travel agency can only see documents relating to transactions of its own agency or of its subordinate agencies.

When searching for travel transaction records using the document number, the user enters the document (e.g., ticket) number into block 408 in the corresponding portion 402 of the retrieval screen 400. Air carrier codes include three digits. For example, the carrier code for US Airways is 037. If the user incorrectly enters the document number, the user may click the “Reset” button, which will clear all of the entered data. Assuming the user correctly enters the document number, the user then clicks the “Search” button, which, instructs the web browser on the client computer 102 to send the access codes to the server computer 118.

When searching for travel transaction records associated with the ARC number, the user enters the ARC number into block 410 of the corresponding portion 404 of the retrieval screen 400. The user also enters the Period End Date (“PED”) into block 412. In comparison to searching for travel transaction records using a document number, searching for travel transaction records via an ARC number and a PED may increases the number of transactions records returned to the user because sending by a document number will only return the documents having the same transaction number while searching for documents with an ARC number and a PED returns all documents relating to a particular travel agency within a certain timeframe.

The PED data is entered in the following format: two digits for the month (MM); two digits for the day (DD) of the month; and four digits for the year (CCYY). If the user incorrectly enters the ARC number and/or the PED, the user may click the “Reset” button, which will clear all of the entered data. Assuming the user correctly enters the data, the user then clicks the “Search” button, which, instructs the web browser on the client computer 102 to send the access codes to the server computer 118.

Both search screens of the retrieval screen 400 allow the user of the client computer 102 to search for “Settled” transaction records and “Initial” transaction records. A settled transaction record includes transaction data as processed by ARC. That is, the settled transaction record is the same as shown on the travel agency's sales report. An initial transaction record is the transaction data as it appeared in the first instance of recording by ARC. The travel agency is able to make changes to the initial transaction record before it is submitted to ARC for processing. However, after ARC processes the travel transaction record, the travel agency cannot alter the data. Nevertheless, the present invention allows a user to search for both settled and initial transaction records.

The settled and initial travel transaction records are stored in the database 120. Specifically, the data from which the travel transaction records are created is stored as data elements within the database 120. Thus, upon receiving either of the two types of requests for travel transaction records from the client computer 102, the server computer 118 searches the database 120 for the requested data. That is, the server computer 118 communicates with the database 120 to determine whether that database 120 includes the requested data within its data elements. If the database 120 does not have the requested data or the user is not authorized to view such data, the server computer 118 sends an appropriate response to the client computer 102.

However, if the database 120 has the requested data, the server computer 118 retrieves the data from the data elements in the database 120 and dynamically creates a summary of the travel transaction record corresponding to the request. As discussed above, ARC assigned a transaction number to each document. Thus, when the server computer 118 receives a request for a particular document using a document number, the server computer 118 determines the transaction number assigned to the requested document. Thereafter, the server computer 118 retrieves a list of all documents having that same transaction number. And, as mentioned above, a summary of the travel transaction record is a summary of each document having the same transaction number (i.e., within the same transaction chain). Thus, the server computer 120 lists certain information from each of the documents having the same transaction number. Once the server computer 118 creates the summary of the travel transaction record, the server computer 118 sends the summary to the client computer 102. That is, the server computer 118 sends the requested data to the client computer 102 in the form of a response screen.

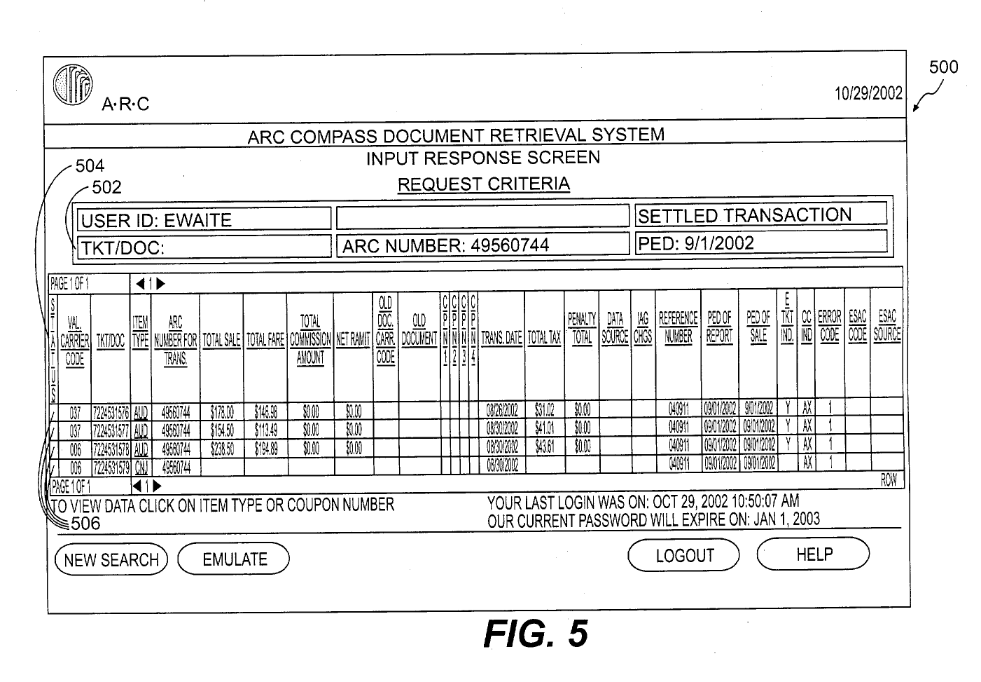

Referring to FIG. 5, there is shown one embodiment of a response screen 500, which the server computer 118 would send to the client computer 102 in reply to receiving a request for settled transaction data, wherein such request included an ARC number and a PED. As shown in FIG. 5, the response screen 500, which is a GUI, may include three sections: a search request criteria table 502; column headings 504; and lines of data summarizing information pertaining the respective documents within the travel transaction record 506. It shall be understood that a travel transaction record preferably includes the column headings 504 and the lines of data 506, but the travel transaction record may also include information the same or equivalent to that in the criteria table 502. FIG. 5 illustrates 28 column headings. However, it shall be understood that additional column headings may be included.

Because the user requested data by providing an ARC number and a PED, the search request criteria table 502 includes the User ID, the ARC number and the PED. FIG. 5 illustrates a single transaction that has four documents associated with that transaction. Those four documents include two audit (“AUD”) coupons and a two-part ticket—audit (“AUDI”) coupon and conjunction coupon (“CNJ”). As discussed above, ARC assigns a transaction number to related documents within a chain of documents. Accordingly, when a user searches the database 120 for documents, via the server computer 118, the server computer 118 retrieves a list all documents associated with the same transaction number, thereby providing the user with a list summarizing all of the documents within the transaction chain. Thus, the four documents have the same transaction number, which is maintained in the database but preferably not displayed on the summary of the travel transaction record. However, it shall be understood that it is within the scope of this invention to display the transaction number on the summary of the travel transaction record if so desired.

The third section of the response screen—the lines of sales report data—may include thousands of lines of transaction information. Thus, screen breaks occur every 25 lines, thereby allowing multiple documents associated with a single transaction to appear on multiple pages. Furthermore, when 25 or more documents are retrieved, multiple response screens will be produced, and the multiple response screens will be indicated as “Page 1 of X <<1 2 3 4 5 etc.>>”.

A data field is associated with each column heading and sales report line. And some of those data fields are associated with the process to retrieve a document image and other data fields are not. The data fields associated with image documents will be referred to as “document image links” because a document image corresponding to that data (i.e., document summary) may be retrieved by clicking the respective data field. Document image links are distinguishable because they may be highlighted with a different color, underlined, or some other obvious means of distinguishing text. Clicking the data field refers to selecting a data field by pointing the cursor, via movement of the mouse, to the data field and tapping on the mouse button, thereby pressing it down and immediately releasing it.

The document image links in FIG. 5 are the data fields that have underlined text. For example, referring to FIG. 5, under the column heading “Item Type”, the data fields identified as “AUD” and “CNJ” are document image links. Thus, if the user of the client computer 102 displays a response screen similar to either the response screen of FIG. 5, the user may request an image of the supporting document associated with the corresponding travel transaction record by clicking a document image link. By clicking the document image link, the web browser instructs the client computer 102 to send a request to the server computer 118 for the document image of the supporting document that corresponds to that item of the travel transaction record.

Upon receiving the request for the document image, the server computer 118 recognizes the type of document being requested and dynamically creates a template for that type of document. For example, if the user of a client computer 102 clicked the “AUD” in the line of the summary of the travel transaction record having “TKT/DOC” 7224531578, the server computer 118 would recognize that the user was requesting a document image of an auditor coupon and dynamically generate a document image of an auditor coupon template.

Also, upon receiving the request for the document image, the server computer 118 communicates with the database 120 to retrieve the data corresponding to the requested document from the data elements in the database 120. Assuming the database 120 has the requested data and the request originated from an authorized user, the server computer 118 retrieves the data. Upon retrieving the requested data, the server computer 118 creates a document image 600 of the document—from which the data originated—using the retrieved data and the dynamically created template. According to the example discussed above, the server computer 118 would dynamically create a document image of an auditor's coupon corresponding to “TKT/DOC” 7224531578, which is the third item of the summary of the travel transaction record, using the dynamically created template and the retrieved data.

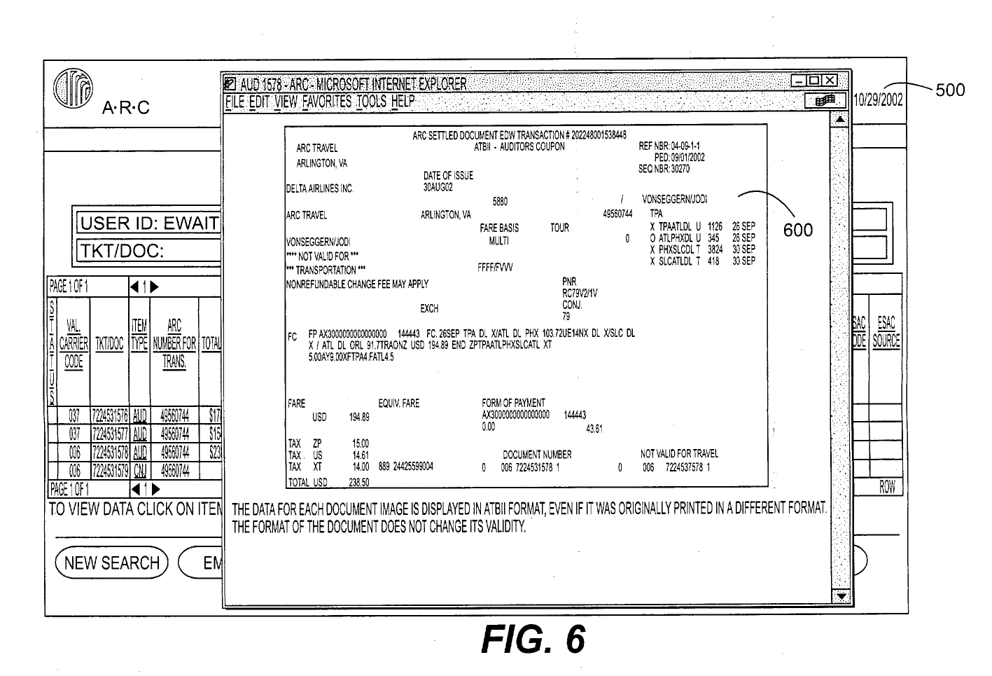

The resulting document image would be the same as or equivalent to document image 600 illustrated in FIG. 6. As illustrated on the top line of the document image 600, the travel transaction number, such as 202248001538448, is preferably included. However, it shall be understood that it is within the scope of this invention to omit the travel transaction number from the document image 600 of the document.

After creating the document image 600, the server computer 118 sends the document image 600 to the client computer 102. Upon receiving the document image 600, the client computer 102 displays it over the response screen 500, as seen in FIG. 7. Once the document image 600 is displayed on the display of the client computer 102, the user may view and/or print (via a web browser) such image on a local printer, thereby negating the need to request a hard copy of the support document from the travel agent (or ARC), who would manually have to reproduce a photocopy of the support document and send it to the requesting party. Thus, the present invention allows a user of a client computer to remotely retrieve, view, electronically forward (via e-mail) and print travel transaction records and their supporting documentation.

Although the invention has been described and illustrated with respect to the exemplary embodiments thereof, it should be understood by those skilled in the art that the foregoing and various other changes, omissions and additions may be made without departing from the spirit and scope of the invention.

What is claimed is:

1. A computer-implemented method of retrieving a document image of a travel document, the method comprising the steps of:
(a) establishing communication with a server computer through a network of computers, wherein said server computer communicates with a database that hosts data corresponding to travel documents;
(b) requesting from said server computer a summary of a travel transaction record;
(c) receiving from said server computer said summary of said travel transaction record;
(d) requesting from said server computer a document image of a travel document corresponding to said travel transaction record; and
(e) receiving said document image of said travel document from said server computer.

2. The method of claim 1 wherein the step of establishing communication with a server computer through a network of computers comprises the step of sending login information to said server computer.

3. The method of claim 1 wherein the step of requesting from said server computer a summary of a travel transaction record comprises the step of sending a search request to said server computer.

4. The method of claim 3 wherein said search request comprises a document number.

5. The method of claim 3 wherein said search request comprises an ARC number and a Period End Date.

6. The method of claim 1 wherein the step of requesting a document image of said travel transaction record comprises the step of selecting a data field in said summary of said travel transaction record.

7. The method of claim 6 wherein the step of selecting a data field comprising the step of clicking said data field.

8. The method of claim 1 further comprising the step of printing a copy of said document image.

9. The method of claim 1 wherein said network of computers is the Internet.

10. The method of claim 1 wherein said network of computers is the World Wide Web.

11. A system for retrieving a document image of a travel document, the system comprising:
(a) a memory;
(b) computer readable program code stored on said memory, said computer readable program code comprising instructions for:
(i) receiving a request from a client computer for a travel document;
(ii) retrieving from a database data corresponding to said travel document;
(iii) creating a document image of said travel document using said data; and
(iv) sending said document image of said travel document to said client computer; and
(c) a central processor coupled to said memory, wherein said central processor executes said instructions of said computer readable program code.

12. The system of claim 11 wherein said computer readable program code further comprises instructions for:
(a) receiving a request from a client computer for a summary of a travel transaction record;
(b) retrieving from a database data corresponding to said travel transaction record;
(c) creating a summary of said travel transaction record using said data; and
(d) sending said summary of said travel transaction record to said client computer.

13. The system of claim 12 wherein said request for a summary of a travel transaction record comprises a document number.

14. The system of claim 12 wherein said request for a summary of a travel transaction record comprises an ARC number and a Period End Date.

15. The system of claim 11 further comprising means for communicating with said client computer.

16. The system of claim 15 further comprising means for communicating with said client computer via the Internet.

17. The system of claim 15 further comprising means for communicating with said client computer via the World Wide Web.

18. A system for retrieving a document image of a travel document, the system comprising:
(a) means for establishing communication with a client computer;
(b) means for receiving a request from a client computer for a travel document;
(c) means for retrieving from a database data corresponding to said travel document;
(d) means for creating a document image of said travel document using said data; and
(e) means for sending said document image of said travel document to said client computer.

19. The system of claim 18 wherein said system further comprises:
(a) means for receiving a request from a client computer for a summary of a travel transaction record;
(b) means for retrieving from a database data corresponding to said travel transaction record;
(c) means for creating a summary of said travel transaction record using said data; and
(d) means for sending said summary of said travel transaction record to said client computer.

20. The system of claim 19 wherein said request for a summary of a travel transaction record comprises a document number.

21. The system of claim 19 wherein said request for a summary of a travel transaction record comprises an ARC number and a Period End Date.

22. A computer readable program, comprising:
(a) code for receiving a request from a client computer for a travel document;
(b) code for retrieving from a database data corresponding to said travel document;
(c) code for creating a document image of said travel document using said data; and
(d) code for sending said document image to said client computer.

23. The computer readable program of claim 22 further comprising:
(a) code for receiving a request from a client computer for a summary a travel transaction record;
(b) code for retrieving from a database data corresponding to said travel transaction record;
(c) code for creating a summary of said travel transaction record using said data; and
(d) code for sending said summary of said travel transaction record to said client computer.

24. A computer-implemented method of creating a document image of a travel document, the method comprising the steps of:
(a) receiving a request from a client computer for a travel document;
(b) retrieving from a database data corresponding to said travel document;
(c) creating a document image of said travel document using said data; and
(d) sending said document image of said travel document to said client computer.

25. The method of claim 24 further comprising the steps of:
(a) receiving a request from a client computer for a summary of a travel transaction record;
(b) retrieving from a database data corresponding to said travel transaction record;
(c) creating a summary of said travel transaction record using said data; and
(d) sending said summary of said travel transaction record to said client computer.
